(19) United States
(12) Patent Application Publication
(10) Pub. No.: US 2013/0312081 A1
(43) Pub. Date: Nov. 21, 2013

(54) MALICIOUS CODE BLOCKING SYSTEM

(71) Applicants: Ki Beom SHIM, Seoul (KR); Myung Kuc HWANG, Seoul (KR); Jong Chul KIM, Seoul (KR); Jong Hwa PARK, Seoul (KR)

(72) Inventors: Ki Beom SHIM, Seoul (KR); Myung Kuc HWANG, Seoul (KR); Jong Chul KIM, Seoul (KR); Jong Hwa PARK, Seoul (KR)

(73) Assignees: ESTSECURITY CO., LTD., Seoul (KR); ESTSOFT CORP., Seoul (KR)

(21) Appl. No.: 13/895,803

(22) Filed: May 16, 2013

(30) Foreign Application Priority Data
May 18, 2012 (KR) 10-2012-0053067

(51) Int. Cl. H04L 29/06

(52) U.S. Cl. CPC H04L 63/0236; H04L 63/1425
USPC 726/13

(57) ABSTRACT

Disclosed is a malicious code blocking system including: a fake website detector that repeatedly accesses a website to be monitored to detect an attack, stores a detection log of the attacked site, and provides a URL address of the attacked site or server; a malicious URL storage that temporarily stores a URL address of the attacked site or server and stores a status flag indicating whether or not a malicious URL list containing information on malicious URLs changes; and a URL filter associated with a user terminal to monitor a network packet transmitted or received by the user terminal, check whether or not the status flag changes in a case where DNS query request for visiting a specific site is generated, and update a malicious URL list containing information on a malicious URL based on information stored in the malicious URL storage if the status flag changes.

### CROSS REFERENCES TO RELATED APPLICATIONS

The present invention contains subject matter related to Korean Patent Application No. 2012-0053067, filed in the Korean Patent Office on May 18, 2012, the entire contents of which are incorporated herein by reference.

### BACKGROUND OF THE INVENTION

1. Field of the Invention

The present invention relates to a technology for blocking a malicious code in a wired/wireless communication network such as the Internet.

2. Description of Related Art

Recently, as a super high-speed Internet environment is established, damages caused by a malicious code distributed via a program, an e-mail, and the like are increasingly reported.

Typically, a malicious code may degrade computer performance or deface an initial page of a user's web browser into an unintended site. In addition, a user's computer may be abused as a spam mail distribution server or a host computer for a distributed denial-of-service (DDoS) attack, or the malicious code may be used to steal user's identification information.

The malicious code may be installed to infect a user's computer in various forms such as Active-X, Java Applet, Java WebStart, .NET ClickOnce, Flash, and user created contents (UCC). However, such various forms are common in that an original file is received from a Web server via a hypertext transfer protocol (HTTP).

Recently, in order to prevent such a malicious code from being distributed, a variety of studies have been made for a defense technology.

Most of all, in existing Web application firewalls or general firewalls, a malicious code is blockedbased on Internet protocol (IP) addresses (e.g., black URL list) or malicious patterns known in advance and stored in user's equipment.

In this manner, such a malicious code blocking method in which a rule or policy is established and stored in user's equipment in advance may defend a DDoS attack or a worms attack in a network terminal, but may have a limitation in prevention of malicious code infection via a webpage. For example, if an advertisement server or a webpage is infected due to internal vulnerability when a user accesses a portal or news site via a browser, a user may unwittingly access a malicious code distribution server.

Such a web attack has the following characteristics.

First, an attacker checks, in advance, whether or not a virus vaccine distributor monitors a webpage and a malicious code to be exploited in the hacking. Second, once a malicious code starts to be distributed, an attacker changes a distribution server at an unspecific time point to escape from monitoring and blocking of the distribution server. Third, an attacker tends to try an attack on a site where a lot of users frequently access during peak Internet traffic hours in order to widely spread infection within a short time. In this manner, an attacker watches for a temporal gap before a virus vaccine distributor analyzes an attack pattern and updates a virus vaccine after the web attack. Therefore, the existing method employed in the user's equipment fails to effectively defend distribution of malicious codes via a website.

### SUMMARY OF THE INVENTION

In view of the problems described above, the present invention provides a malicious code blocking system capable of effectively defending a webpage attack or malicious code injection that may be irregularly performed at an unspecific time by making a list of websites, where a lot of users frequently access, such as a portal, news, and community websites, repeatedly checking and determining such websites to immediately provide users with information on the attacked webpage and server as soon as detected, and systemizing such a process.

According to an aspect of the invention, there is provided a malicious code blocking system including: a fake website detector that repeatedly accesses a website to be monitored to detect whether or not a malicious action including a malicious code occurs, stores a detection log of a site where the malicious action is detected in a database, and provides a uniform resource locator (URL) address of the site where the malicious action is detected and a URL of a server used to distribute the malicious code; a temporary malicious URL storage that temporarily stores a URL address of the site where the malicious action is detected, provided from the fake website detector, and a URL of the server used to distribute the malicious code, and stores a status flag indicating whether or not a malicious URL list containing information on malicious URLs changes; and a URL filter associated with a user terminal to monitor a network packet transmitted or received by the user terminal, check whether or not the status flag of the temporary malicious URL storage changes in a case where a domain name system (DNS) query request for visiting a specific website is generated, and update a malicious URL list containing information on a malicious URL of the user terminal based on information stored in the temporary malicious URL storage if the status flag changes, wherein the fake website detector compares an existing malicious URL list with a URL of the site where the malicious action is detected and changes the status flag when the URL of the site where the malicious action is detected is sent to the temporary malicious URL storage if the URL of the site where the malicious action is detected is a new URL not listed in the existing malicious URL list.

In the malicious code blocking system, the fake website detector may cause the URL of the site where the malicious action is detected to be stored in the temporary malicious URL storage for a predetermined time period from a last detection time point if the malicious action is repeatedly detected from a specific site for a predetermined time period.

In the malicious code blocking system, the malicious action may include shellcode injection.

In the malicious code blocking system, the URL filter may perform URL filtering for a hypertext transfer protocol (HTTP) query request packet.

In the malicious code blocking system, the website to be monitored may be selected, in advance, based on the number of users who access the corresponding site.

In the method of the related art, for an attack made by injecting a malicious code to create a new rule and hacking a site at an unspecific time point, malicious data is stored, and an infected site or server is blocked based on the stored data. However, in this method, it is difficult to immediately defend such an attack. According to the present invention, a server determines whether or not there is an attack using a detector on a minute-by-minute base and immediately provides URL information to the user's terminal. Therefore, it is possible to effectively block a malicious action by minimizing a temporal gap until the malicious code is detected.

According to the present invention, the URL filter associated with the user's terminal is operated in a simple manner because it does not necessitate a lot of data. In addition, since only the URL is compared, it is not necessary to perform pattern matching unlike other blocking programs known in the art. As a result, it is possible to provide a fast web surfing.

Furthermore, data on the malicious URL list stored in the temporary storage according to the present invention are not accumulated, and a user is not required to manually register or cancel an item of the attacked server from the list, which may waste man power. As a result, it is possible to prevent a cumbersome work and an additional cost for site maintenance.

### BRIEF DESCRIPTION OF THE DRAWINGS

The foregoing and additional features and characteristics of this disclosure will become more apparent from the following detailed description considered with reference to the accompanying drawings, wherein:

FIG. 1 is a conceptual diagram illustrating a malicious code blocking system according to an embodiment of the present invention; and

FIG. 2 is a flowchart illustrating a malicious code blocking method in the malicious code blocking system according to an embodiment of the present invention.

### DETAILED DESCRIPTION OF THE INVENTION

Hereinafter, embodiments of the invention will be described in detail with reference to the accompanying drawings. It is noted that like reference numerals denote like elements throughout overall drawings. In addition, descriptions of well-known apparatus and methods may be omitted so as to not obscure the description of the representative embodiments, and such methods and apparatus are clearly within the scope and spirit of the present disclosure.

The terminology used herein is only for the purpose of describing particular embodiments and is not intended to limit the invention. As used herein, the singular forms “a”, “an” and “the” may be intended to include the plural forms as well, unless the context clearly indicates otherwise. It is further to be noted that, as used herein, the terms “comprises”, “comprising”, “include”, and “including” indicate the presence of stated features, integers, steps, operations, units, and/or components, but do not preclude the presence or addition of one or more other features, integers, steps, operations, units, and/or components, and/or combination thereof.

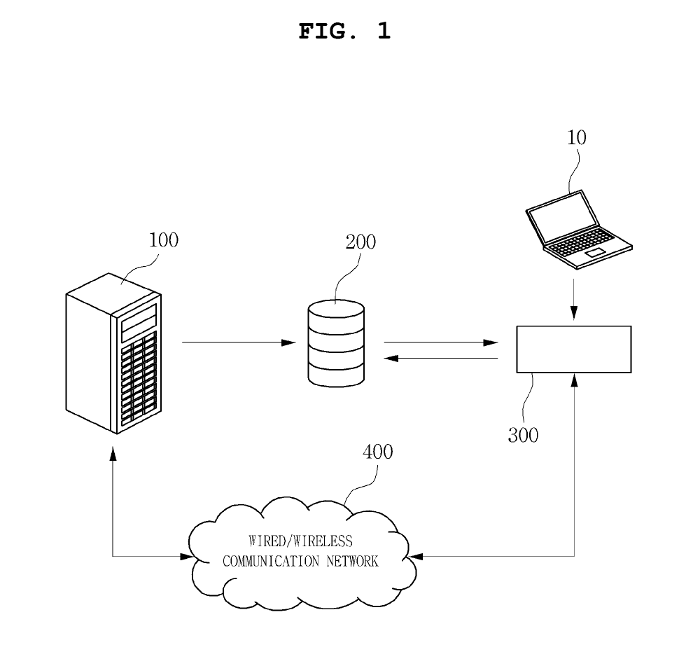

FIG. 1 is a conceptual diagram illustrating a malicious code blocking system according to an embodiment of the invention.

Referring to FIG. 1, the malicious code blocking system according to an embodiment of the invention includes a fake website detector 100, a temporary malicious URL storage 200, and a URL filter 300. According to an embodiment of the invention, the fake website detector 100 and the URL filter 300 of a user terminal 10 communicate via a wired/wireless network 400. The wired/wireless network 400 may be any one of various wired and/or wireless communication networks such as the Internet.

The fake website detector 100 repeatedly accesses websites to be monitored based on a virtualized system to detect a malicious action such as shellcode injection or normal file change. In the malicious code blocking system, the website to be monitored may be selected, in advance, based on the number of users who access the corresponding site.

According to an embodiment of the invention, in a case where a malicious action is detected, the fake website detector 100 stores a detection log of the corresponding site and sends, to the temporary malicious URL storage 200, a uniform resource locator (URL) of the site where the malicious action is detected and a URL of the server exploited to distribute the malicious code.

According to an embodiment of the invention, if a malicious action is repeatedly detected from a specific site for a predetermined time period H, the malicious URL may be stored in the temporary malicious URL storage 200 and be then eliminated after a predetermined time period +a from the last detection time point. According to an embodiment of the present invention, the time period +a is set in order to prevent the malicious URL from being eliminated from the temporary malicious URL storage 200 before the repeated check is completed because the fake website detector 100 repeatedly performs detection and determination on a regular basis.

The temporary malicious URL storage 200 sets a flag for notifying a change status of the malicious URL list. This advantageously minimizes a network load because the list may be updated only when the status flag changes without comparing the entire list in a case where the URL filter 300 included in the user terminal 10 accesses the temporary malicious URL storage 200.

According to the present invention, the fake website detector 100 compares the existing list and automatically changes the status flag when new malicious URL information is sent.

The URL filter 300 is associated with the user terminal 10 to monitor a network packet.

According to an embodiment of the invention, the URL filter 300 checks the status flag of the temporary malicious URL storage 200 in a case where a domain name system (DNS) query request is generated to visit a website. If the status flag changes, the malicious URL list of the user terminal 10 is updated. Then, the URL filter 300 performs URL filtering for a hypertext transfer protocol (HTTP) query request packet.

According to an embodiment of the present, it is preferable that the URL filter 300 be associated with the user terminal 10. Here, the user terminal 10 may include a terminal capable of network communication, such as a personal computer (PC), a laptop computer, and a tablet PC.

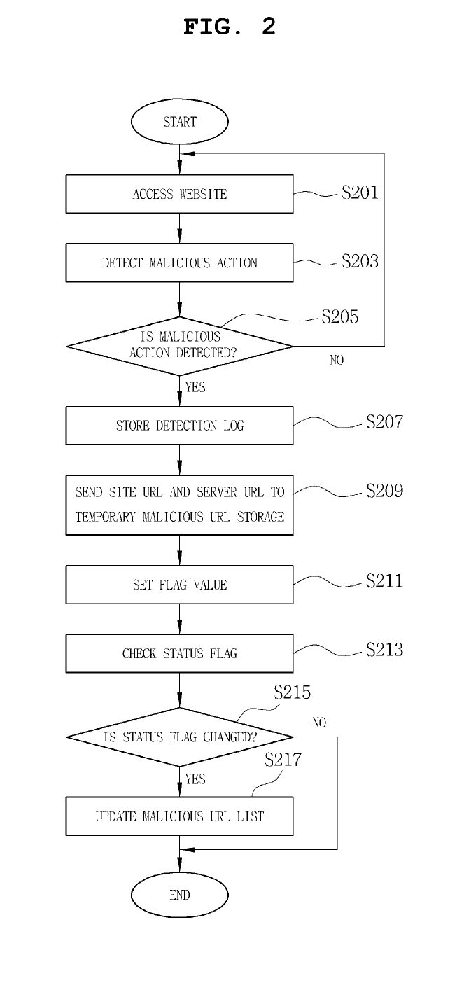

FIG. 2 is a flowchart illustrating a malicious code blocking method in the malicious code blocking system according to an embodiment of the invention.

Referring to FIG. 2, the fake website detector 100 repeatedly accesses websites to be monitored (step S201) and detects whether or not there is a malicious action (step S203). For example, the malicious action may include shellcode injection, normal file change, and the like.

If a malicious action is detected, the fake website detector 100 stores, in a database, a detection log of the site where the malicious action is detected (steps S205 and S207). In addition, the fake website detector 100 sends the URL of the site where the malicious action is detected and the URL of the server used to distribute the malicious code to the temporary malicious URL storage 200 (step S209).

According to an embodiment of the present invention, if a malicious action is repeatedly detected from a specific site for a predetermined time period H, it is preferable that a malicious URL be stored in the temporary malicious URL storage 200 and be then eliminated after a predetermined time period +a from the last detection time point. The time period +a is set in order to prevent the malicious URL from being eliminated from the temporary malicious URL storage 200 before the repeated check is completed because the fake website detector 100 repeatedly performs detection and determination on a regular basis.

The temporary malicious URL storage 200 sets the status flag for notifying a change status of the malicious URL list (step S211). According to an embodiment of the invention, step S211 is to minimize a network load. That is, the list is updated just by checking whether or not the status flag changes without comparing the entire list when the URL filter 300 accesses the temporary malicious URL storage 200. According to the present invention, the fake website detector 100 compares the existing list and automatically changes the status flag when new malicious URL information is sent.

Then, the status flag is checked (step S213) when the URL filter 300 accesses the temporary malicious URL storage 200.

If the status flag changes as a result of the check, the URL filter 300 updates the malicious URL list of the user terminal 10 (steps S215 and S217). Then, the URL filter 300 performs URL filtering for the HTTP query request packet.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

What is claimed is:

1. A malicious code blocking system comprising:
a fake website detector that repeatedly accesses a website to be monitored to detect whether or not a malicious action including a malicious code occurs, stores a detection log of a site where the malicious action is detected in a database, and provides a uniform resource locator (URL) address of the site where the malicious action is detected and a URL of a server used to distribute the malicious code;
a malicious URL storage that temporarily stores a URL address of the site where the malicious action is detected, provided from the fake website detector, and a URL of the server used to distribute the malicious code, and stores a status flag indicating whether or not a malicious URL list containing information on malicious URLs changes; and
a URL filter associated with a user terminal to monitor a network packet transmitted or received by the user terminal, check whether or not the status flag of the temporary malicious URL storage changes in a case where a domain name system (DNS) query request for visiting a specific website is generated, and update a malicious URL list containing information on a malicious URL of the user terminal based on information stored in the malicious URL storage if the status flag changes,
wherein the fake website detector compares an existing malicious URL list with a URL of the site where the malicious action is detected and changes the status flag when the URL of the site where the malicious action is detected is sent to the malicious URL storage if the URL of the site where the malicious action is detected is a new URL not listed in the existing malicious URL list.

2. The malicious code blocking system according to claim 1, wherein the fake website detector causes the URL of the site where the malicious action is detected to be stored in the malicious URL storage for a predetermined time period from a last detection time point if a malicious action is repeatedly detected from a specific site for a predetermined time period.

3. The malicious code blocking system according to claim 1, wherein the malicious action includes shellcode injection.

4. The malicious code blocking system according to claim 1, wherein the URL filter performs URL filtering for a hypertext transfer protocol (HTTP) query request packet.

5. The malicious code blocking system according to claim 1, wherein the website to be monitored may be selected, in advance, based on the number of users who access the corresponding site.
